(19) United States
(12) Patent Application Publication
(10) Pub. No.: US 2018/0268225 A1
(43) Pub. Date: Sep. 20, 2018

(54) PROCESSING APPARATUS AND PROCESSING SYSTEM

(71) Applicant: Kabushiki Kaisha Toshiba, Tokyo (JP)

(72) Inventors: Ai Sakashita, Kawasaki Kanagawa (JP); Nao Mishima, lnagi Tokyo (JP)

(73) Assignee: Kabushiki Kaisha Toshiba, Tokyo (JP)

(21) Appl. No.: 15/690,425

(22) Filed: Aug. 30, 2017

Related U.S. Application Data
(63) Continuation of application No. 15/686,282, filed on Aug. 25, 2017.

(30) Foreign Application Priority Data
Mar. 15, 2017 (JP) 2017-049918
Jul. 12, 2017 (JP) 2017-136061

(51) Int. Cl. G06K 9/00; G06T 7/571; G08G 1/16

(52) U.S. Cl. CPC G06K 9/00798; G06K 9/00805; G06T 2207/30261; G08G 1/162; G06T 7/571

(57) ABSTRACT

According to one embodiment, a processing apparatus includes a memory and a processor. The processor is electrically coupled to the memory and is configured to calculate a size of an object based on a distance map. The distance map is acquired together with an image at one image capture by a single imaging optical system. Information indicative of a distance to the object included in the image is mapped in the distance map.

### CROSS-REFERENCE TO RELATED APPLICATIONS

This application is based upon and claims the benefit of priority from Japanese Patent Applications No. 2017-049918, filed Mar. 15, 2017; and No. 2017-136061, filed Jul. 12, 2017, the entire contents of all of which are incorporated herein by reference.

### FIELD

Embodiments described herein relate generally to a processing apparatus and a processing system.

### BACKGROUND

A technique of acquiring the size of an object, for example, the length between two specified points on an object captured by a stereo camera (compound-eye camera) is known.

### BRIEF DESCRIPTION OF THE DRAWINGS

FIG. 1 is a diagram showing an example of the functional block of a processing apparatus of a first embodiment.

FIG. 2 is a diagram showing an example of the hardware structure of the processing apparatus of the first embodiment.

FIG. 3 is a block diagram showing an example of the structure of an imaging apparatus of the first embodiment.

FIG. 4 is a diagram showing an example of the structure of a filter of the first embodiment.

FIG. 5 is a graph showing an example of transmittance characteristics of a filter area of the first embodiment.

FIG. 6 is an explanatory diagram showing variation of a ray of light by a color-filtered aperture of the first embodiment and a shape of a blur.

FIG. 7 is a diagram showing an example of a blur function of a reference image of the first embodiment.

FIG. 8 is a diagram showing an example of a blur function of a target image of the first embodiment.

FIG. 9 is a diagram showing an example of a convolution kernel of the first embodiment.

FIG. 10 is a diagram showing an example of an image and a distance map of the first embodiment.

FIG. 11 is a flowchart showing an example of the flow of the processing of a processing system of the first embodiment.

FIG. 12 is a diagram showing an example of the output of the size of an object by the processing system of the first embodiment.

FIG. 13 is a diagram showing an example of the output of the traveling distance of an object by the processing system of the first embodiment.

FIG. 14 is an explanatory diagram showing a commonly-used motion capture system.

FIG. 15 is a diagram showing another example of the output of the size of an object by the processing system of the first embodiment.

FIG. 16 is a diagram showing another example of the output of the size of an object by the processing system of the first embodiment.

FIG. 17 is an explanatory diagram showing an application example of the processing apparatus of the first embodiment to a mobile object.

FIG. 18 is an explanatory diagram showing another application example of the processing apparatus of the first embodiment to a mobile object.

FIG. 19 is an explanatory diagram showing an application example of the processing apparatus of the first embodiment to an automatic door system.

FIG. 20 is a diagram showing a modification of the functional block of the processing apparatus of the first embodiment.

FIG. 21 is a diagram showing an example of the functional block of a processing apparatus of a second embodiment.

FIG. 22 is an explanatory diagram showing an application example of the processing apparatus of the second embodiment to a robot.

FIG. 23 is a diagram showing an example of the functional block of a processing apparatus of a third embodiment.

FIG. 24 is an explanatory diagram showing an application example of the processing apparatus of the third embodiment to a mobile object.

### DETAILED DESCRIPTION

In general, according to one embodiment, a processing apparatus includes a memory and a processor. The processor is electrically coupled to the memory and is configured to calculate a size of an object based on a distance map. The distance map is acquired together with an image at one image capture by a single imaging optical system. Information indicative of a distance to the object included in the image is mapped in the distance map.

Embodiments will be described hereinafter with reference to the accompanying drawings.

### First Embodiment

Firstly, a first embodiment will be described.

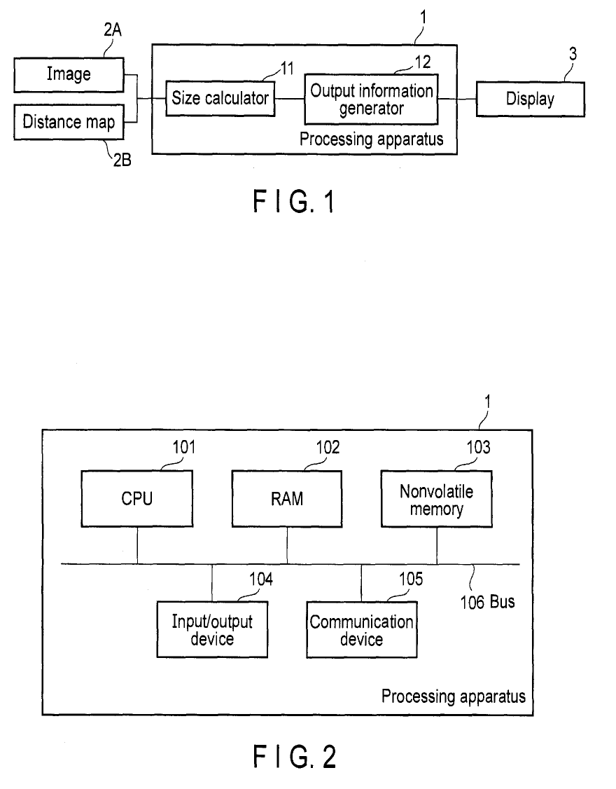

FIG. 1 is a diagram showing an example of the functional block of a processing apparatus of the first embodiment.

The processing apparatus 1 calculates the size of an object from a distance map (distance image) 2B acquired by use of image capture and outputs the calculated size of the object. The processing apparatus 1 may calculate the size of an object also from an image 2A. The size of an object may be displayed on a display 3 concurrently with the image 2A, for example. The image 2A and the distance map 2B will be described later in detail, but for example, the image 2A and the distance map 2B may be directly acquired from an imaging apparatus which generates the image 2A and the distance map 2B, or may be acquired from a server which stores the image 2A and the distance map 2B and is connected via a network. The display 3 is, for example, a liquid crystal display, a touchscreen display where a touch panel is mounted on a liquid crystal display, etc.

The processing apparatus 1 may constitute a processing system together with the imaging apparatus (which generates the image 2A and the distance map 2B) and the display 3. The processing system may be realized, for example, as a camera, a recording device such as a driving recorder, a smartphone with a camera function, a personal computer with a camera function, a monitoring system, a mobile object such as a vehicle, a flying object or a robot with a camera function, etc.

As shown in FIG. 1, the processing apparatus 1 includes a size calculator 11 and an output information generator 12.

The size calculator 11 is a processing portion having the function of calculating the size of an object on the image 2A from the distance map 23. The size calculator 11 may calculate the size of an object also from the image 2A. The output information generator 12 is a processing portion having the function of generating and outputting output information based on the size of an object. The output information is, for example, information for displaying concurrently with the image 2A.

FIG. 2 is a diagram showing an example of the hardware structure of the processing apparatus 1.

As shown in FIG. 2, the processing apparatus 1 includes a CPU 101, an RAM 102, a nonvolatile memory 103, an input/output device 104 and a communication device 105, and further includes a bus 106 which connects the CPU 101, the RAM 102, the nonvolatile memory 103, the input/output device 104 and the communication device 105 to each other.

The CPU 101 is a processor which realizes the respective processing portions of the processing apparatus 1 including the size calculator 11 and the output information generator 12 shown in FIG. 1 by loading a computer program stored in the nonvolatile memory 103 into the RAM 102 and executing the computer program. Here, it is assumed that the processing portions of the processing apparatus 1 are realized by one CPU 101, that is, a single processor, but the processing portions of the processing apparatus may also be realized by a plurality of processors. The processing portion of the processing apparatus 1 may be realized by a dedicated electronic circuit. The RAM 102 is a storage medium used as a main memory, and the nonvolatile memory 103 is a storage medium used as an auxiliary storage device.

The input/output device 104 is a module which executes input and output such as input of the image 2A and the distance map 2B from the imaging apparatus, input of an instruction from a user, and output of a display screen image to the display 3. The instruction from the user may be input in accordance with an operation of a keyboard, a pointing device, an operation button, etc., and if the display 3 is a touchscreen display, the instruction from the user may be input in accordance with a touch operation on the touchscreen display. The communication device 105 is a module which executes, for example, communication with an external device via a network, wireless communication with an external device which exists on the periphery, etc. The image 2A and the distance map 2B may be acquired by the communication device 105.

Here, the image 2A and the distance map 2B will be described in detail.

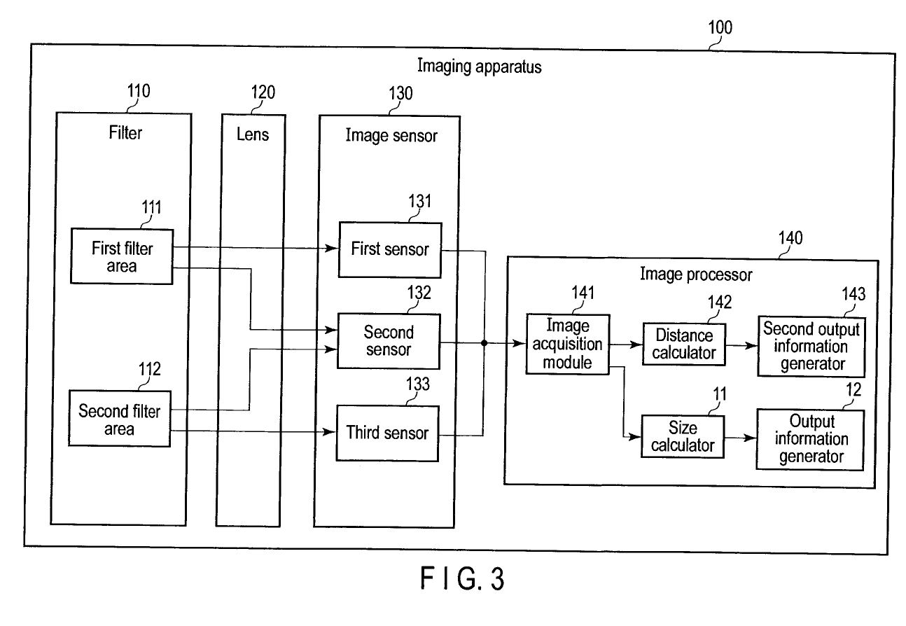

FIG. 3 is a block diagram showing an example of the structure of the imaging apparatus which generates the image 2A and the distance map 2B.

As shown in FIG. 3, the imaging apparatus 100 includes a filter 110, a lens 120, an image sensor 130 and an image processor (processing apparatus) 140. In FIG. 3, the arrow from the filter 110 to the image sensor 130 indicates the path of light. Further, the arrow from the image sensor 130 to the image processor 140 indicates the path of an electrical signal. The image processor 140 further includes an image acquisition module 141, a distance calculator 142 and a second output information generator 143, in addition to the above-described size calculator 11 and output information generator 12.

The image sensor 130 generates an image by receiving light transmitted through the filter 110 and the lens 120 and converting (photoelectrically converting) the received light to an electrical signal. As the image sensor 130, for example, a charge coupled device (CCD) or a complementary metal oxide semiconductor (CMOS) is used. The image sensor 130 includes, for example, an imaging element (first sensor 131) which receives red (R) light, an imaging element (second sensor 132) which receives green (G) light and an imaging element (third sensor 133) which receives blue (B) light. Each imaging element receives light of a corresponding wavelength band and converts the received light into an electrical signal. By performing A/D conversion of this electrical signal, a color image (image 2A) can be generated. It is also possible, by using electrical signals of a red imaging element, a green imaging element and a blue imaging element, to generate an R image, a G image and a B image, respectively. That is, a color image, an R image, a G image and a B image can be generated concurrently with each other. In other words, the imaging apparatus 100 can acquire a color image, an R image, a G image and a B image at one image capture. The filter 110, the lens 120 and the image sensor 130 constitute a single optical system.

The filter 110 includes two or more color filter areas. Each color filter has an asymmetrical shape with respect to the optical center of the imaging apparatus. For example, a part of the wavelength band of light transmitted through one color filter area overlaps a part of the wavelength band of light transmitted through another color filter area. For example, the wavelength band of light transmitted through one color filter area may include the wavelength band of light transmitted through another color filter area.

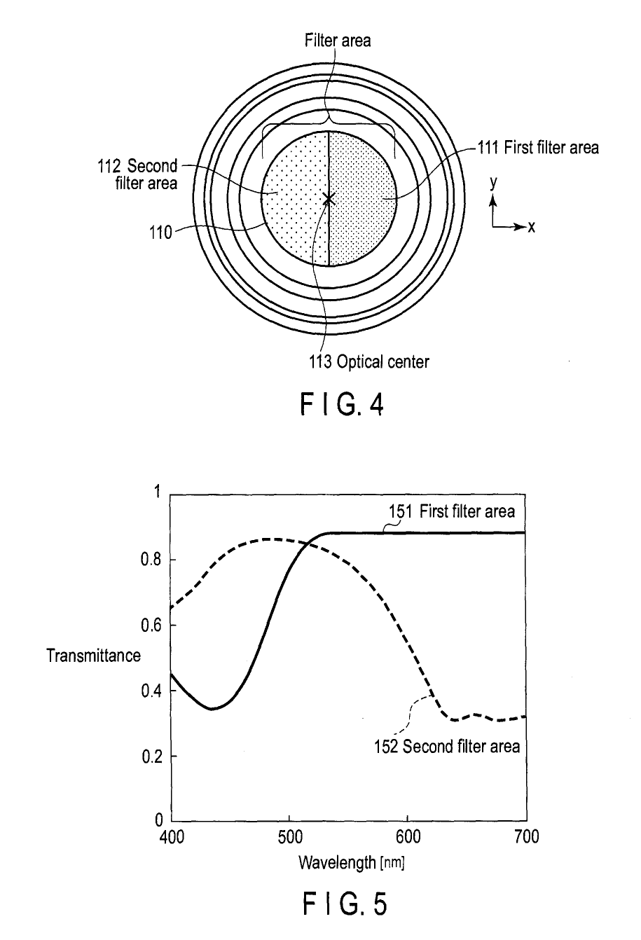

FIG. 4 shows an example of the structure of the filter 110. The filter 110 is composed of, for example, two color filter areas colored with different colors, namely, a first filter area 111 and a second filter area 112. The center of the filter 110 coincides with an optical center 113 of the imaging apparatus 100. Each of the first filter area 111 and the second filter area 112 has an asymmetrical shape with respect to the optical center 113. Further, for example, the filter areas 111 and 112 do not overlap each other, and the whole filter area is composed of these two filter areas 111 and 112. In the example shown in FIG. 4, the first filter area 111 and the second filter area 112 have the shapes of semicircles of the circular filter 110 which is divided by a line segment crossing the optical center 113. Further, the first filter area 111 is, for example, a yellow (Y) filter area, and the second filter area 112 is, for example, a cyan (C) filter area. The following description will be based on the assumption that the filter 110 shown in FIG. 4 is used.

For example, by arranging the filter 110 shown in FIG. 4 in the aperture portion of the camera, a color-filtered aperture having such an aperture structure that the aperture portion is divided into two colors is formed. The image sensor 130 generates an image based on the ray of light transmitted through this color-filtered aperture. In the path of light which enters the image sensor 130, the lens 120 may be arranged between the filter 110 and the image sensor 130. In the path of light which enters the image sensor 130, the filter 110 may be arranged between the lens 120 and the image sensor 130. In the case of providing a plurality of lenses 120, the filter 110 may be arranged between two lenses 120.

The light of the wavelength band corresponding to the second sensor 132 is transmitted thorough both the yellow first filter area 111 and the cyan second filter area 112. The light of the wavelength band corresponding to the first sensor 131 is transmitted through the yellow first filter area 111 but is not transmitted through the cyan second filter area 112. The light of the wavelength band corresponding to the third sensor 133 is transmitted through the cyan second filter area 112 but is not transmitted through the yellow second filter area 112.

In a case where light of a certain wavelength band is transmitted through a filter or a filter area, this means that the filter or the filter area allows light of the wavelength band to pass through at a high transmission rate, and that attenuation of light of the wavelength band (that is, reduction of the amount of light) through the filter or the filter area is very little. Further, in a case where light of a certain wavelength band is not transmitted through a filter or a filter area, this means that the light is blocked by the filter or the filter area, and for example, the filter or the filter area allows light of the wavelength band to pass through at a low transmission rate, and attenuation of light of the wavelength band through the filter or the filter area is great. For example, a filter or a filter area absorbs light of a certain wavelength band and attenuates the light.

FIG. 5 is a graph showing an example of transmittance characteristics of the first filter area 111 and the second filter area 112. As shown in FIG. 5, in transmittance characteristics 151 of the yellow first filter area 111, light of the wavelength bands corresponding to the R image and the G image is transmitted at a high transmission rate, and light of the wavelength band corresponding to the B image is hardly transmitted. Further, in transmittance characteristics 152 of the cyan second filter area 112, light of the wavelength bands corresponding to the B image and the G image is transmitted at a high transmission rate, and light of the wavelength band corresponding to the R image is hardly transmitted.

Therefore, light of the wavelength band corresponding to the R image is transmitted only through the yellow first filter area 111, and light of the wavelength band corresponding to the B image is transmitted only through the cyan second filter area 112, and thus the shape of a blur on the R image and the B image varies depending on a distance d to an object, more specifically, a difference between the distance d and a focal distance d_{f}. Further, since the filter areas 111 and 112 have an asymmetrical shape with respect to the optical center, the shape of a blur on the R image and the B image varies depending on whether an object is located on the front side or the back side of the focal distance d_{f}. That is, the shape of a blur on the R image and the B image is unbalanced.

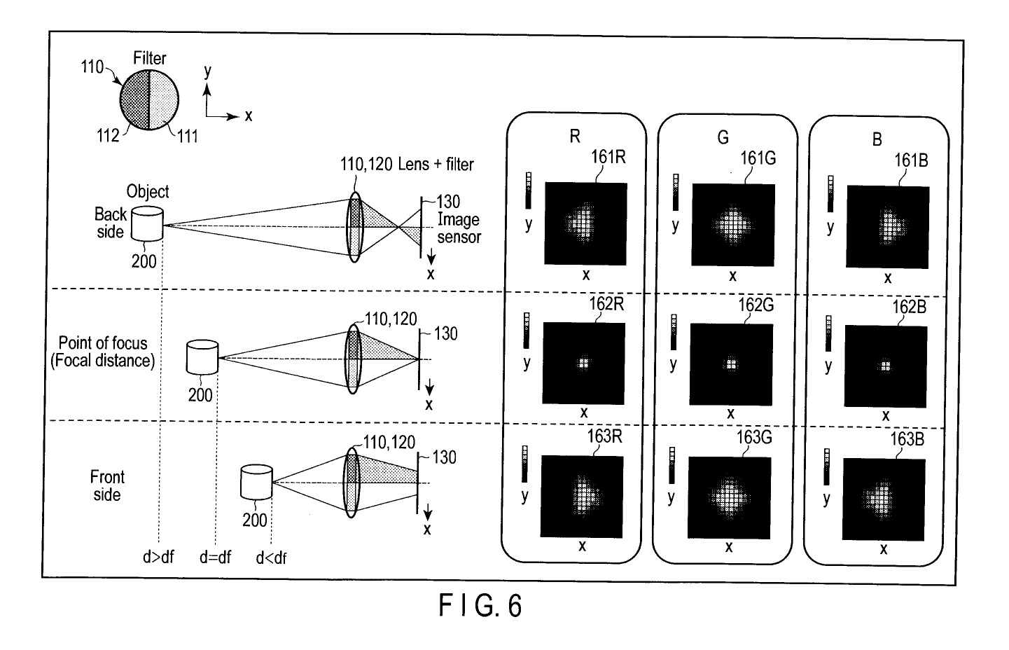

With reference to FIG. 6, variation of the ray of light by the color-filtered aperture equipped with the filter 110 and the shape of the blur will be described.

If an object 200 is located on the back side of the focal distance d_{f} (d>d_{f}), blurring occurs in the image captured by the image sensor 130. A blur function (point spread function: PSF) showing the shape of the blur on this image varies among the R image, the G image and the B image. That is, a blur function 161R of the R image shows the shape of a left-sided blur, a blur function 161G of the G image shows the shape of a balanced blur, and a blur function 161B of the B image shows the shape of a right-sided blur.

Further, if the object 200 is located at the focal distance d_{f} (d=d_{f}), blurring hardly occurs in the image captured by the image sensor 130. The blur function showing the shape of the blur on this image is the same among the R image, the G image and the B image. That is, a blur function 162R of the R image, a blur function 162G of the G image and a blur function 162B of the B image show the shape of a balanced blur.

Still further, if the object 200 is located on the front side of the focal distance d_{f} (d<d_{f}), blurring occurs in the image captured by the image sensor 130. A blur function showing the shape of the blur on this image varies among the R image, the G image and the B image. That is, a blur function 163R of the R image shows the shape of a right-sided blur, a blur function 163G of the G image shows the shape of a balanced blur, and a blur function 163B of the B image shows the shape of a left-sided blur.

The image processor 140 of the imaging apparatus 100 calculates the distance to an object by using these characteristics.

The image acquisition module 141 acquires the G image, the blur function of which shows the shape of a balanced blur, as a reference image. Further, the image acquisition module 141 acquires one or both of the R image and the B image, the blur functions of which show the shape of a one-sided blur, as a target image. The target image and the reference image are images captured by one imaging apparatus at the same point in time.

The distance calculator 142 calculates the distance to an object by acquiring a convolution kernel which increases, when added to the target image, correlation with the reference image, from a plurality of convolution kernels. Further, the distance calculator 142 generates the distance map from the calculated distance. The convolution kernels are functions which respectively add different blurs to the target image. Here, the distance calculation processing by the distance calculator 142 will be described in detail.

The distance calculator 142 generates a correction image where a correction is made to the shape of a blur of the target image by adding a different blur to the target image based on the acquired target image and reference image. Here, the distance calculator 142 uses a plurality of convolution kernels which are prepared based on the assumption that the object is located at predetermined distances, generates a correction image where a correction is made to the shape of a blur of the target image, acquires a distance which increases the correlation between the correction image and the reference image, and calculates the distance to the object.

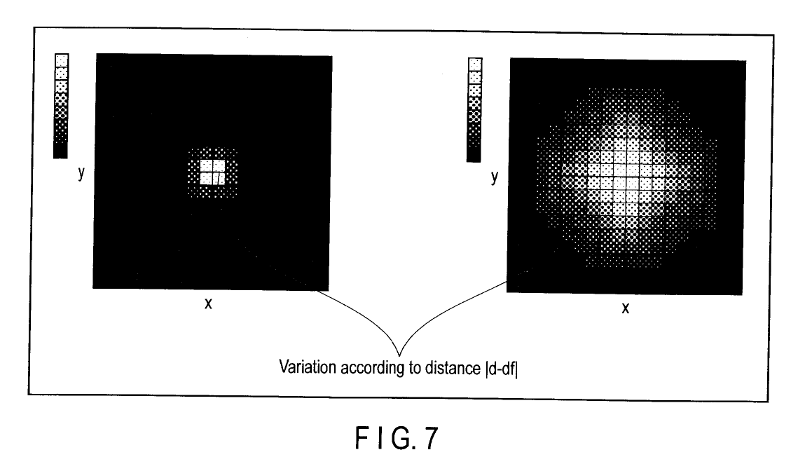

The blur function of the captured image is determined by the aperture shape of the imaging apparatus 100 and the distance between the position of the object and the point of focus. FIG. 7 is a diagram showing an example of the blur function of the reference image. As shown in FIG. 7, since the shape of the aperture through which light of the wavelength band corresponding to the second sensor 132 passes is a circle, that is, a point-symmetrical shape, the shape of the blur shown by the blur function does not vary between the front side and back side of the point of focus, but the width of the blur varies depending on the distance between the position of the object and the point of focus. The blur function showing the blur can be expressed as a Gaussian function where the width of the blur varies depending on the distance between the position of the object and the point of focus. Note that the blur function may be expressed as a pillbox function where the width of the blur varies depending on the distance between the position of the object and the point of focus.

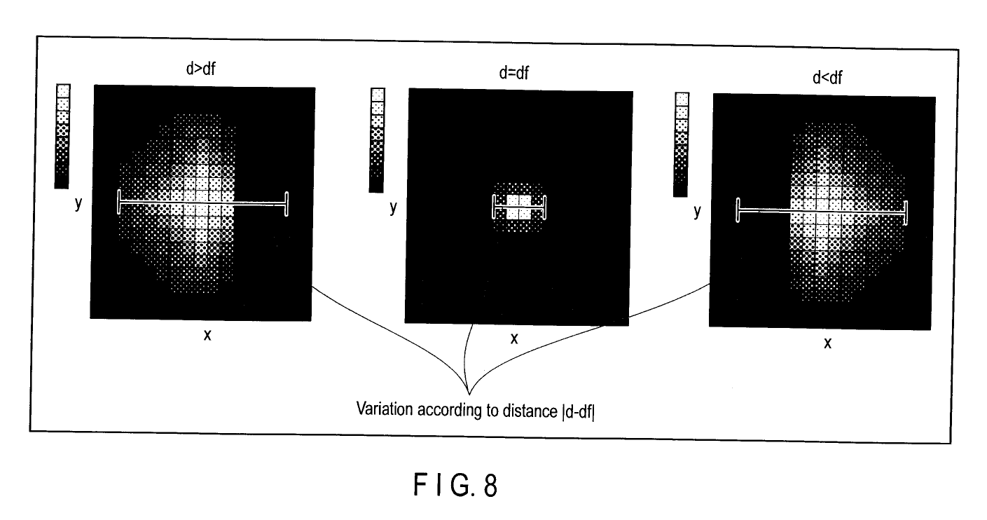

FIG. 8 is a diagram showing an example of the blur function of the target image. Note that the center of each image is (x₀, y₀)=(0, 0). As shown in FIG. 8, if the object is located on the far side of the point of focus, that is, if d>d_{f}, the blur function of the target image (for example, the R image) can be expressed as a Gaussian function where, when x>0, the width of the blur decreases due to attenuation of light in the first filter area 111. Further, if the object is located on the near side of the point of focus, that is, if d<d_{f}, the blur function of the target image can be expressed as a Gaussian function where, when x<0, the width of the blur decreases due to attenuation of light in the first filter area 111.

Further, the convolution kernels for correcting the shape of the blur of the target image to the shape of the blur of the reference image can be acquired by analyzing the blur function of the reference image and the blur function of the target image.

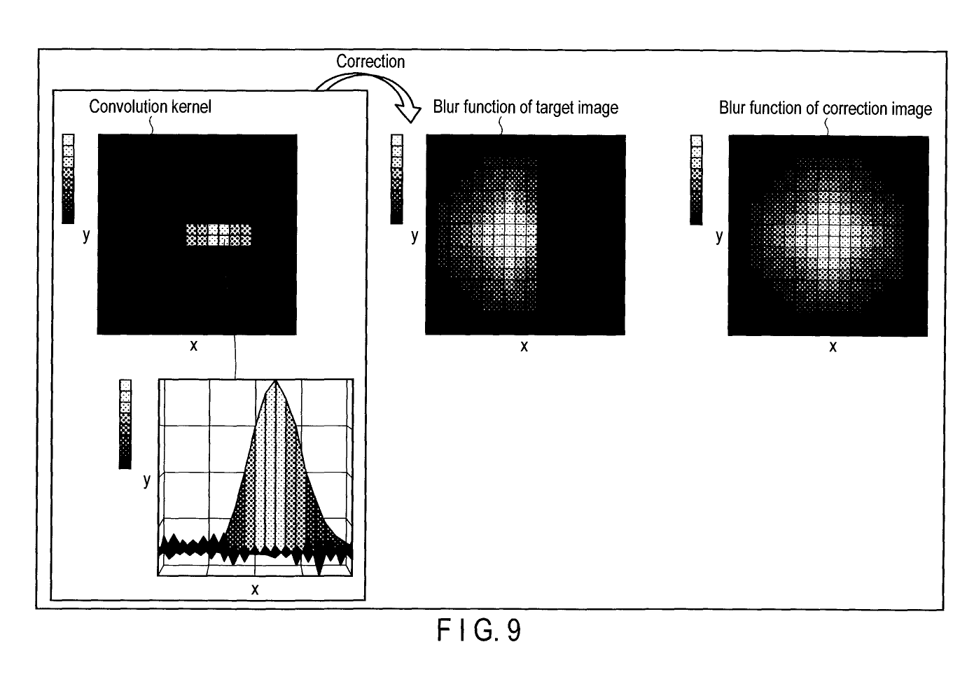

FIG. 9 is a diagram showing an example of the convolution kernel. Note that the convolution kernel shown in FIG. 9 is a convolution kernel in the case of using the filter 110 shown in FIG. 4. As shown in FIG. 9, the convolution kernel crosses the center point of the line segment at the boundary between the first filter area 111 and the second filter area 112 and is distributed over a straight line (in the vicinity of a straight line) which is orthogonal to this line segment. The distribution has such a mountain shape as shown in FIG. 9 that the peak (position on the line x and height) and the distribution from the peak vary depending on the assumed distance. The shape of the blur of the target image can be corrected to the shapes of various blurs assuming arbitrary distances by using the convolution kernel. That is, a correction image assuming an arbitrary distance can be generated.

The distance calculator 142 acquires a distance at which the shape of the blur of the generated correction image is most closely approximated to or coincides with the shape of the blur of the reference image, from each pixel of the captured image. As the degree of coincidence of the shape of the blur, the correlation between the correction image and the reference image in an arbitrary-size rectangular area which is centered at each pixel may be calculated. In the calculation of the degree of coincidence of the shape of the blur, any existing similarity evaluation methods may be used. The distance calculator 142 calculates the distance to the object with respect to each pixel by acquiring a distance at which the correction image and the reference image have the highest correlation with each other.

For example, the existing similarity evaluation methods include the sum of squared differences (SSD), the sum of absolute differences (SAD), the normalized cross-correlation (NCC), the zero-mean normalized cross-correlation (ZNCC), the color alignment measure, etc. In the present embodiment, the color alignment measure using such characteristics that color components of a natural image locally have a linear relationship is used. In the color alignment measure, an index of correlation is calculated from variance of color distribution in a local area which is centered at a target pixel of a captured image.

In this way, the distance calculator 142 generates a correction image where a correction is made to the shape of the blur of the target image according to the filter area by the convolution kernel of the assumed distance, acquires a distance at which the correlation between the generated correction image and the reference image increases, and calculates the distance to the object.

Further, the distance calculator 142 generates the distance map from the calculated distance. For example, the distance map is generated as an image where the pixel value of each pixel indicates a distance. For example, from the front side to the back side of the focal position, from a value indicating a long wavelength (red) to a value indicating a short wavelength (purple) are assigned, respectively. Accordingly, in the distance map, information indicating the distance to the object is mapped in accordance with the area of the image, and the pixel value is used as the information indicating the distance to the object. Since the distance map generated as an image can be displayed, for example, the positional relationship of a plurality of objects in the depth direction can be identified by colors. The second output information generator 12 generates output information including the distance map generated by the distance calculator 142 and outputs the output information.

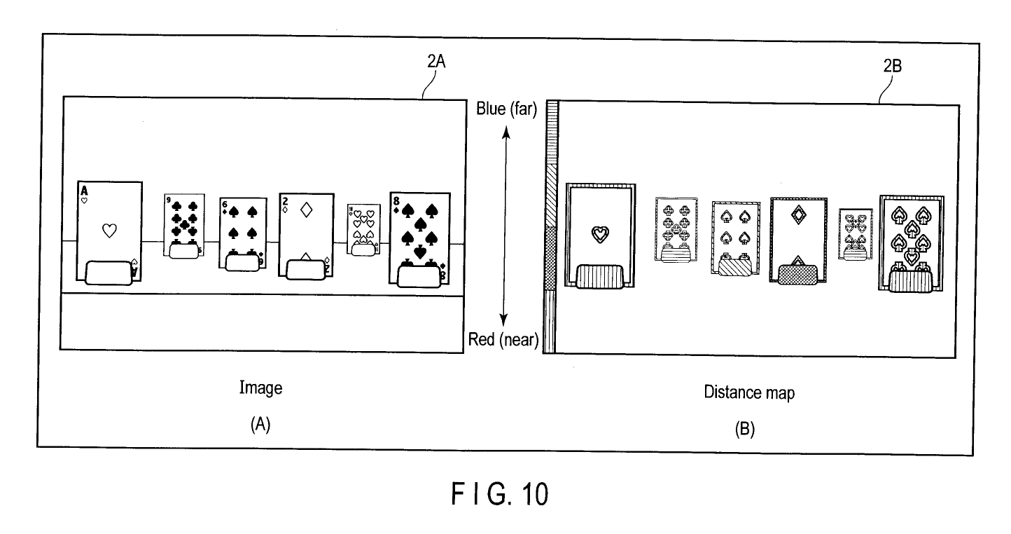

FIG. 10 is a diagram showing an example of the image 2A and the distance map 2B generated by the imaging apparatus 100.

In FIG. 10, (A) is a display example of the image 2A and (B) is a display example of the distance map 2B. In the distance map where the pixel value of each pixel becomes a value indicating a color having a longer wavelength as an object is located on the nearer side of the focal position and becomes a value indicating a color having a shorter wavelength as an object is located on the farther side of the focal position, as shown in FIG. 10 (B), the distance map will be displayed as an image where an object on the front side is colored with a reddish color and an object on the back side is colored with a purplish color.

Next, the processing of the processing apparatus 1 which acquires the image 2A and the distance map 2B and executes various processing will be described.

If the focal distance for capturing the image 2A is known, the ratio between the length of the object on the captured image and the length of the actual object can be acquired from the ratio between the distance from the optical center to the image center and the distance from the optical center to the object. Further, in the distance map 2B, since a pixel value indicates a distance as described above, each pixel can be projected (mapped) in real space (three-dimensional space). The processing apparatus 1, more specifically, the size calculator 11 acquires the size of the object corresponding, for example, to the distance between two points specified on the image 2A by projecting (mapping) each pixel in real space (three-dimensional space). Further, the output information generator 12 generates, for example, output information for displaying the acquired size of the object to be overlaid on the image 2A, that is, output information for displaying the size of the object and the image concurrently with each other, and outputs the output information to the display 3. Note that the image 2A is used, in the process of acquiring the size of the object, for identification of the object and specification of the portion to be measured on the object. In other words, the size calculator 11 which is provided with two points to be measured on the image 2A can acquire the size of the object only from the distance map 2B and does not require the image 2A. Hereinafter, the case of acquiring the size of the object using the image 2A and the distance map 2B will be described.

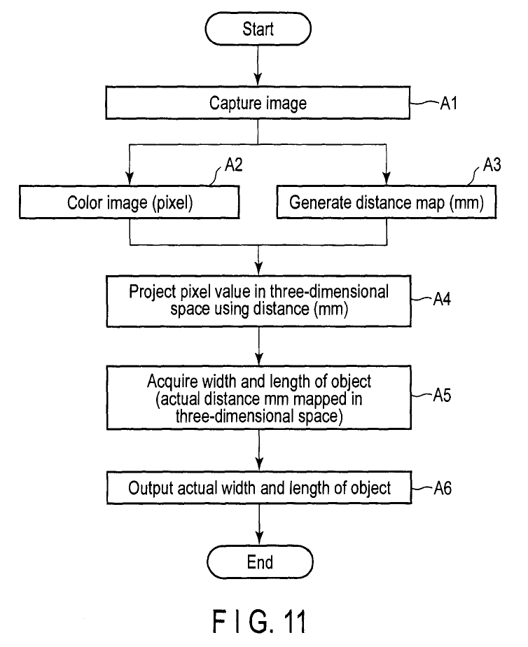

FIG. 11 is a flowchart showing an example of the flow of the processing of the processing system including the processing apparatus 1.

Firstly, an image is captured by the imaging apparatus 100 (step A1). The imaging apparatus 100 generates the image 2A (step A2) and generates the distance map 2B (step A3). The image 2A and the distance map 2B generated by the imaging apparatus 100 are acquired by the processing apparatus 1.

For example, the processing apparatus 1 displays the image 2A by the display 3 and receives an instruction which specifies any one of objects in the image 2A, an instruction which specifies two points in the image 2A, etc. This instruction also functions as a request for acquiring the size of the object at the same time. When the request for acquiring the size of the object is made, the processing apparatus 1 projects each pixel of the distance map 2B in three-dimensional space by using the distance indicated by the pixel value of each pixel (step A4). For example, when receiving an instruction which specifies one object, the processing apparatus 1 acquires the width, length, etc., of the object from the distance (actual distance) between the pixels projected in three-dimensional space (step A5). The processing apparatus 1 outputs the actual size of the object to the display 3 to be displayed concurrently with the image 2A in such a manner as to be overlaid on the image 2A, for example (step A6).

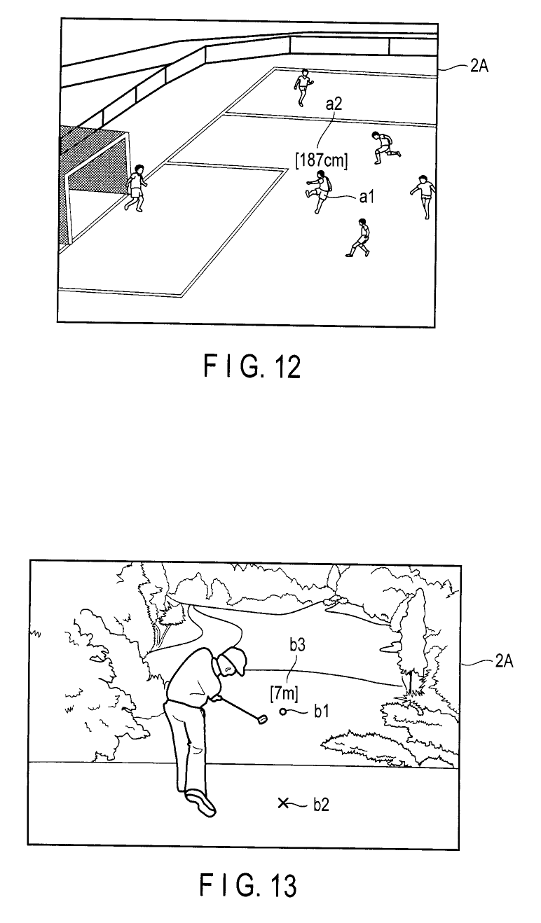

FIG. 12 is a diagram showing an example of the output of the size of the object by the processing system including the processing apparatus 1. This processing system is assumed to be realized as an imaging apparatus which films a video at a frame rate of 30 fps (captures thirty images per second), for example.

The processing apparatus 1 sequentially displays the captured image 2A on the display 3, and for example, if a certain position is specified on the image 2A, analyzes the image 2A and identifies the object including the specified position, and also uses the distance map 2B corresponding to the image 2A and projects at least those of the pixels of the image 2A which include the object in three-dimensional space. As to the analysis of the image 2A for identifying the object including the specified position, not particular means but any existing means may be applied. For example, the processing apparatus 1 may acquire the size of the object in a predetermined direction or between two specified points from the distance between the pixels projected in three-dimensional space. The predetermined direction and the two specified points may vary from object to object. The processing apparatus 1 may acquire the maximum length or the minimum length of the object. For example, the size may be displayed on the display 3 in such a manner as to be overlaid on the image 2A. For example, the size may be displayed near the object in the image 2A. Further, when an object is specified and if one point of the object is specified, the longest distance may be acquired from distances from one ends to the other ends of line segments which pass this point. Still further, for example, the type of the object may be identified, and the distance between two points according to this type may be determined as the size. An interface for the setting of the target portion for size acquisition according to the type may be provided in the processing apparatus 1. After the size of the object is displayed, for example, if a predetermined operation is performed, the processing apparatus 1 returns the display of the display 3 to the display mode of sequentially displaying the latest image 2A.

FIG. 12 shows an example where, while a soccer game is being filmed, an instruction which specifies one player a1 among a plurality of players (objects) in the image 2A is provided, and a height a2 of this player is displayed near the player a1 in the image 2A.

In this way, according to the processing apparatus 1, it is possible to acquire the size of a moving object such as a player during a game from the image 2A and the distance map 2B acquired by a monocular camera.

Although FIG. 12 shows an example of acquiring and presenting the size of a specified object, it is also possible to acquire and present the sizes of all the objects in the image 2A. In that case, the sizes of some specified objects in the image 2A may be displayed on the image 2A by popup windows. Further, instead of displaying in such a manner as to be overlaid on the image 2A, it is also possible to display concurrently with the image 2A by displaying the reduced-size image 2A, opening another window next to the reduced-size image 2A and listing the acquired sizes in this window.

Still further, according to the processing apparatus 1, not only the size of the object but also the traveling distance of the object can be acquired. FIG. 13 is a diagram showing an example of the output of the traveling distance of the object by the processing system including the processing apparatus 1. This processing system is assumed to be realized also as an imaging apparatus which films a video.

FIG. 13 shows an example of displaying the flying distance of a golf ball in a tee shot during a golf game, more specifically, an example of displaying a traveling distance b3 of a golf ball b1 from a tee position b2 on the image 2A in real time.

If the target object for the traveling direction acquisition (here, the golf ball b1) and the initial position of the object are known, the processing apparatus 1 can acquire the distance between the initial position and the current position, that is, the traveling distance of the object in real time by projecting, with respect to each frame of the image captured every 1/30 second, at least those of the pixels of the image 2A which include the object, in three-dimensional space, based on the distance map 2B. The image capture target area may be moved in such a manner as to track the object. Further, although FIG. 13 shows an example of the image 2A which captures a direction which substantially coincides with the traveling direction of the golf ball b1, the image 2A is not limited to this and may be any image as long as the image is captured from a position where the object can be continuously tracked.

In this way, according to the processing apparatus 1, the traveling distance of the moving object can be acquired.

Further, since the processing apparatus 1 can acquire the traveling distance of the object, the processing apparatus 1 can be applied to a motion capture system.

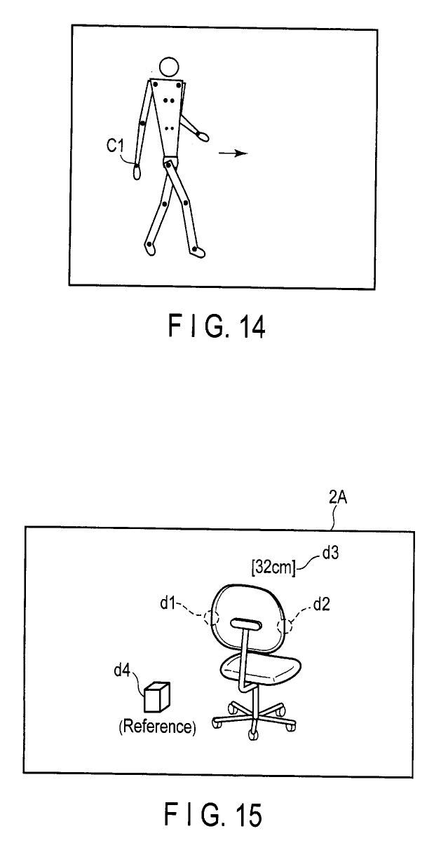

In the motion capture system in general, a sensor c1 which measures movement, etc., is mounted on various parts of the body of a subject as shown in FIG. 14. On the other hand, the processing system including this processing apparatus 1 does not require such preparation and can measure movement of an object. For example, the processing apparatus 1 can measure movement of the object every 1/30 second by projecting, with respect to each frame of the image captured every 1/30 second, each pixel of the image 2A in three-dimensional space based on the distance map.

In this way, according to the processing apparatus 1, motion capture can be realized.

Further, the function of this processing apparatus 1 can be realized as a measurement tool, etc., which is an application installed in a smartphone having a camera function (which can generate the distance map). For example, if the user wishes to know the size of a product displayed in a shop, the user can acquire the size of the product by capturing the image of the product even if the user does not have any measure. Note that the touchscreen display of the smartphone corresponds to the display 3.

For example, it is assumed that the user wishes to measure the various sizes of a chair displayed in a furniture shop. In this case, firstly, the measurement tool is activated, and the image 2A of the chair such as that shown in FIG. 15 is captured by the camera function of the smartphone. The measurement tool displays the image 2A on the touchscreen display of the smartphone. Further, the measurement tool projects each pixel of the image 2A in three-dimensional space based on the distance map 2B.

The user can find out the distance between two points by specifying one end and the other end. If the user wishes to measure the width of the backrest of the chair, the user performs touch operations on the touchscreen display in such a manner as to touch one end (d1) of the backrest and then touch the other end (d2) of the backrest in the lateral direction. As the method of specifying two points on the image 2A, various methods can be adopted. For example, it is possible to apply a method of displaying a bar on the touchscreen display and stretching the bar to conform the leading end and the terminal end of the bar to the ends (d1 and d2) of the backrest in the lateral direction. When two points are specified on the image 2A, the measurement tool acquires the actual size between the two specified points by using the coordinates of two pixels projected in three-dimensional space, and displays the size on the touchscreen display of the smartphone, for example, in such a manner as to be overlaid on the image 2A (d3).

Further, when two points are specified on the image 2A, the distance to be measured is not necessarily the linear distance between these two points. For example, if two points on the outer surface of the curved object are specified, the outer peripheral distance along the curved outer surface can also be acquired. The outer peripheral distance is, for example, the shortest distance between two points along the curved outer surface. The outer peripheral distance can be acquired from the sum of the distance between certain adjacent pixels on the line which connects these two points. The measurement tool may include a first mode which measures the linear distance between two points, and a second mode which measures the outer peripheral distance between two points. Based on the user's mode setting via the input portion, either the direction distance or the outer peripheral distance can be acquired and displayed. Further, the measurement tool may acquire and display both the linear distance and the outer peripheral distance. A third mode which measures the linear distance and the outer peripheral distance between two points may be further included, and if the third mode is set, the linear distance and the outer peripheral distance may be acquired and displayed.

Further, for example, a reference (d4) may be captured together with a measurement target product, which is provided together with the measurement tool or a commodity having a standardized size. By acquiring the size of the reference from the image 2A, it is possible to execute calibration which absorbs an individual difference of the camera function of the smartphone. A correction value for calibration may be provided, for example, in the measurement tool as a parameter, etc., before shipment of the smartphone.

In this way, according to the function of the processing apparatus 1, it is possible to realize a measurement tool which can acquire the sizes of various objects such as a product displayed in a shop from the image 2A and the distance map 2B which are acquired by a monocular camera.

Further, the processing apparatus 1 can be applied to a monitoring system.

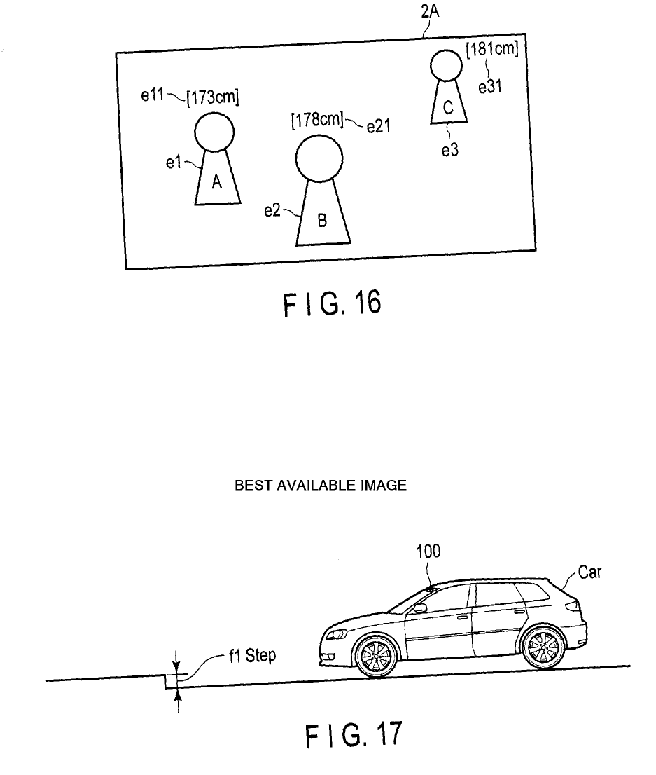

FIG. 16 shows an example of the image 2A captured by a monitoring camera (which can generate the distance map 2B) installed for monitoring, for example, passersby in a hallway in a commercial facility, where passersby (e1, e2 and e3) are identified by the processing apparatus 1 and the heights (e11, e21 and e31) of the passersby acquired by the processing apparatus 1 are displayed in such a manner as to be overlaid thereon. For example, if a security guard finds a suspicious person on the image 2A, the height of the person, which is one of important information indicating the feature of the person, can be acquired instantly.

Further, for example, if an object appeared to be a knife is identified, instead of simply performing processing in response to the identification, only if the length of the blade exceeds a predetermined length, a warning may be displayed by the display 3, or if an audio output portion is connected, a warning sound may be output from the audio output portion. Alternatively, if a predetermined object including a knife is identified, the length of a predetermined portion of the object may be acquired and displayed. If no suspicious point is found in a passerby or in an object that a passerby carries, the display 3 may produce a display, accordingly, or the audio output portion may output a sound, accordingly.

Further, the processing apparatus 1 may not always perform identification and size acquisition of the passerby and the object that the passerby carries (such as the previously-described knife), but when the user specifies a position on the image 2A, the processing apparatus 1 may be switched to a special mode, and in the special mode, the processing apparatus 1 may perform identification, tracking, size acquisition, display, etc., of the object including the specified position. The special mode may be switched to the normal mode, for example, if a target object disappears from the image 2A or a predetermined operation is performed.

In this way, according to the processing apparatus 1, the sizes of a passerby and an object that the passerby carries can be acquired from the image 2A and the distance map 2B acquired by a monocular camera, and a monitoring system which executes warning processing, etc., according to the acquired size can be realized.

Further, the processing apparatus 1 can be applied to a support system which supports the control and operation of a mobile object such as a car.

For example, as shown in FIG. 17, it is assumed that a mobile object is a car and the imaging apparatus 100 is mounted in such a manner as to capture an image in the traveling direction. Further, a situation where a step f1 exists in the traveling direction of the car is assumed.

In this case, the processing apparatus 1 measures the step f1 from the image 2A and the distance map 2B generated by the imaging apparatus 100, determines whether the car can run over the step f1 and presents a determination result to a driver by the display 3. If the car cannot run over the step f1, a warning sound may be further output from an audio output portion installed in the car.

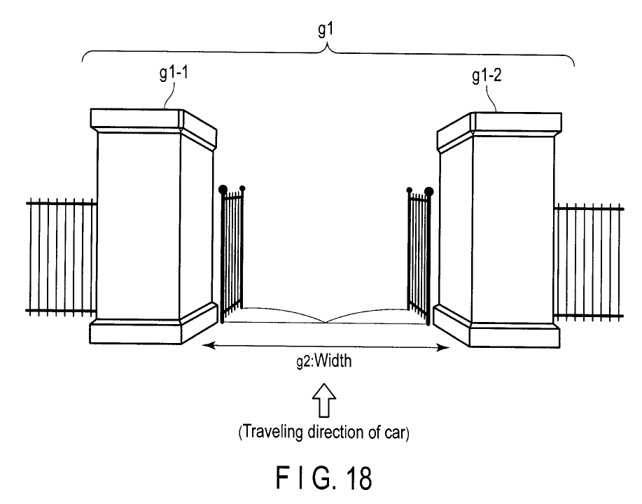

Now, as shown in FIG. 18, a situation where a gate g1 exists in the traveling direction of the car is assumed. In this case, from the image 2A and the distance map 2B generated by the imaging apparatus 100, the processing apparatus 1 measures a width g2 between an object g1-1 and an object g1-2, determines whether the car can pass through and presents a determination result to the driver by the display 3. If the car cannot pass through, a warning sound may be further output from the audio output portion installed in the car.

In this way, according to the processing apparatus 1, it is possible to perform processing for supporting the control and operation of a mobile object based on the image 2A and the distance map 2B acquired by a monocular camera. In light of a situation where the processing apparatus 1 is mounted on a car, for example, the processing apparatus 1 may be realized as a recording device such as a driving recorder.

Further, the processing apparatus 1 can be applied to an automatic door system.

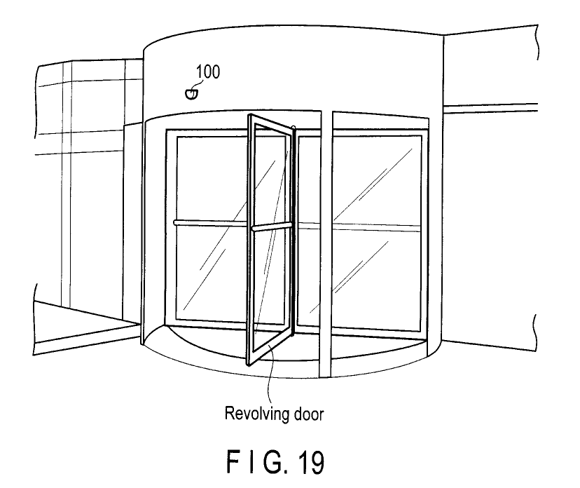

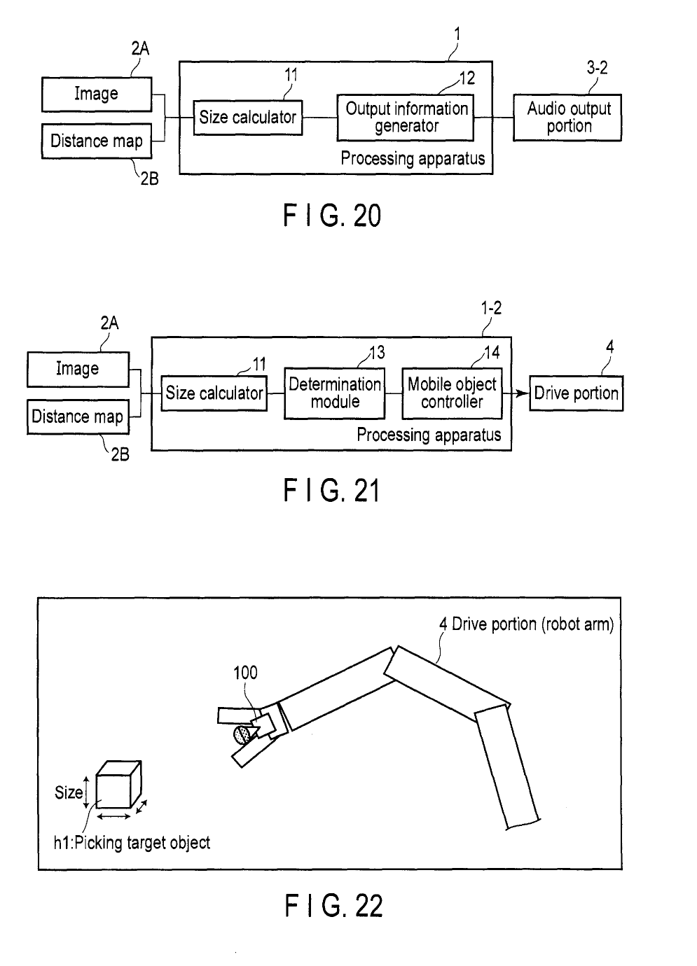

For example, as shown in FIG. 19, an automatic door which continuously revolves at a constant speed is assumed. In the case of a revolving door, a passerby cannot easily find out how large the size of an object which can pass through the door will be. Therefore, for example, the size of the baggage (object) that the passerby carries may be acquired from the image 2A and the distance map 2B generated by the imaging apparatus 100, and if the size of the baggage exceeds the size of an object which can pass through the revolving door, a warning sound is output from an audio output portion installed in the revolving door. In the application to the automatic door system, etc., the processing apparatus 1 may include an audio output portion 3-2 as shown in FIG. 20, in place of the display 3 shown in FIG. 1. The processing apparatus 1 may include both the display 3 and the audio output portion 3-2. The same may be said of the above-described monitoring system and support system. Since the processing apparatus 1 can track movement of an object, only if an object is moving toward the revolving door, the processing apparatus 1 can appropriately acquire the size of the object and determine whether the object can pass through. Therefore, even if an object having a size greater than the size of an object which can pass through passes by the revolving door, it is possible to prevent a warning sound from being output erroneously.

If an obstacle which exists in the traveling direction of a mobile object, such as the step f1 shown in FIG. 17 or the gate g1 shown in FIG. 18 moves, the processing apparatus 1 may acquire information of the obstacle as needed. The information of the obstacle includes, for example, the shape of the obstacle, the width of the overlapping portion of the obstacle and the pathway of the mobile object, etc. The determination module 13 can determine whether the mobile object can pass through according to the change of the obstacle over time. For example, if the shape of the obstacle changes after the determination module 13 determines that the mobile object can pass through, the determination module 13 may determine that the mobile object cannot pass through. Alternatively, if the shape of the obstacle changes after the determination module 13 determines that the mobile object cannot pass through, the determination module 13 may determine that the mobile object can pass through.

In this way, according to the processing apparatus 1, it is possible to execute processing for preventing an accident of an automatic door based on the image 2A and the distance map 2B acquired by a monocular camera.

Further, since the processing apparatus 1 can acquire the size of an object from the image 2A and the distance map 2B acquired by a monocular camera, for example, as compared to a compound-eye camera, the weight of the imaging apparatus 100 can be reduced. Further, costs can be reduced as well. Weight reduction is a matter of importance in the case of mounting on a flying object having a low maximum loading capacity such as a drone, and in this respect, the imaging apparatus 100 which is a monocular camera is more favorable than a compound-eye camera. By mounting the imaging apparatus 100 on a flying object such as a drone, the processing apparatus 1 can be applied to a support system which supports, for example, inspection work of a construction, etc. Additionally, as compared to a compound-eye camera, the imaging apparatus 100 which is a monocular camera does not cause a problem that a compound-eye camera causes, namely, parallax, and thus the imaging apparatus 100 can improve the accuracy of size acquisition. Note that the size may also be calculated by using the image and the distance map acquired by a compound-eye camera. Since the three-dimensional shape of an object can be acquired from the image acquired by a compound-eye camera, the distance between two arbitrary points on the surface of the object can be acquired.

For example, the function of acquiring positional information such as a global position system (GPS) receiver or an altitude sensor is mounted on a drone together with the imaging apparatus 100, the drone is flown around an inspection target construction and the image 2A and the distance map 2B of the external aspect of the construction are acquired, and the image 2A and the distance map 2B of the external aspect of the construction are recorded in association with positional information. For example, if a missing part of the external aspect of the construction is found on the image 2A, the position can be specified and the scale and the shape of the position can be identified.

Alternatively, based on three-dimensional information about the inspection target construction, the drone is flown and the image 2A and the distance map 2B of the construction are acquired, and the image 2A and the distance map 2B of the construction are recorded in association with the three-dimensional information. In this case also, for example, if a missing part of the external aspect of the construction is found on the image 2A, the position can be specified and the scale and the shape of the position can be identified.

Further, when the distance map 2B of the image 2A captured in the previous inspection is compared with the distance map 2B of the image 2A captured in the inspection this time, and if a difference of a predetermined value or more is detected, the corresponding image 2A is displayed in such a manner that the position can be identified, and in this way, for example, the absence of a bolt, etc., can be found without fail. As another example, after occurrence of an earthquake, the situation of damage to the construction can be accurately understood by comparing the distance map 2B of the image 2A captured before the earthquake with the distance map 2B of the image 2A captured after the earthquake.

In addition, the processing apparatus 1 can be used for various purposes by flying the drone and acquiring the image 2A and the distance map 2B. For example, it is possible to use the processing apparatus 1 for the purpose of examining how long an electrical cable is in meters and how the electrical cable is arranged by flying the drone along the electrical cable and acquiring the image 2A and the distance map 2B of the electrical cable.

### Second Embodiment

Next, a second embodiment will be described. Hereinafter, structures the same as those of the first embodiment will be denoted by the same reference numbers, and to avoid redundancy, detailed description of the same structures will be omitted.

FIG. 21 is a diagram showing an example of the functional block of a processing apparatus of the second embodiment.

The processing apparatus 1 calculates the size of an object from the acquired image 2A and distance map (distance image) 2B, and controls the drive of a drive portion 4 of a mobile object based on the calculated size of the object. In the present embodiment, output information is a control signal which partially or entirely controls a processing system.

As shown in FIG. 21, a processing apparatus 1-2 includes the size calculator 11, a determination module 13 and a mobile object controller 14.

The size calculator 11 is a processing portion having the function of calculating the size of an object on the image 2A from the image 2A and the distance map 2B. The determination module 13 is a processing portion having the function of determining how to drive the drive portion 4 based on the size of an object. The mobile object controller 14 is a processing portion having the function of controlling the drive of the drive portion 4 based on the determination of the determination module 13. The hardware structure of the processing apparatus 1-2 is similar to that of the first embodiment, and similarly, the processing portions of the processing apparatus 1-2 may be realized as a single processor or a plurality of processors, for example. A display portion and/or an audio output portion may be connected to the processing apparatus 1-2. The display portion and/or the audio output portion may be connected, for example, to the determination module 13.

The processing apparatus 1-2 may constitute a processing system together with the imaging apparatus (which generates the image 2A and the distance map 2B) and the drive portion 4. The processing system may be realized, for example, as a mobile object such as a vehicle, a flying object or a robot with a camera function.

Firstly, an example of processing in a case where the processing apparatus 1-2 is applied to a support system which supports the control and operation of a mobile object such as a car will be described.

For example, it is assumed that the mobile object is a car and the imaging apparatus 100 is mounted in such a manner as to capture an image in the traveling direction. Further, as in the case of the example described in the first embodiment, a situation where the step f1 exists in the traveling direction of the car as shown in FIG. 17 is assumed.

In this case, the size calculator 11 of the processing apparatus 1-2 measures the step f1 from the image 2A and the distance map 2B generated by the imaging apparatus 100. The determination module 13 determines whether the car can run over the step f1, and if the car cannot run over the step f1, for example, the determination module 13 transmits a signal for stopping the car or changing the traveling direction of the car to the mobile object controller 14. When receiving the signal, the mobile object controller 14 controls the drive of the drive portion 4 to stop the car or change the traveling direction of the car, for example.

Now, as in the case of the example described in the first embodiment, a situation where the gate g1 exists in the traveling direction of the car as shown in FIG. 18 is assumed. The size calculator 11 measures the width g2 of the gate g1 from the image 2A and the distance map 2B generated by the imaging apparatus 100. The determination module 13 determines whether the car can pass through the width g2, and if the car cannot pass through, the determination module 13 transmits a signal for stopping the car or changing the traveling direction of the car to the mobile object controller 14, for example. When receiving the signal, the mobile object controller 14 controls the drive of the drive portion 4 to stop the car or change the traveling direction of the car, for example.

Alternatively, if the determination module 13 determines that the width g2 of the gate g1 is such a size that the car can pass through by folding the side mirrors of the car, the determination module 13 may transmit a signal for folding the side mirrors to the mobile object controller 14. When receiving the signal, the mobile object controller 14 controls the drive of the drive portion 4 to fold the side mirrors.

Next, an example of processing in a case where the processing apparatus 1-2 is applied to an automatic door system will be described.

For example, as in the case of an example described in the first embodiment, an automatic door which continuously revolves at a constant speed as shown in FIG. 19 is assumed. The size calculator 11 acquires, for example, the size of baggage (object) that a passerby carries from the image 2A and the distance map 2B generated by the imaging apparatus 100. The determination module 13 determines whether the size of the baggage is the size of an object which can pass through the revolving door, if the size of the baggage exceeds the size of an object which can pass through the revolving door, the determination module 13 transmits a signal for stopping the revolution of the automatic door to the mobile object controller 14, for example. When receiving the signal, the mobile object controller 14 controls the drive of the drive portion 4 to stop the revolution of the automatic door, for example.

Next, an example of processing in a case where the processing apparatus 1-2 is applied to a robot will be described. Here, for example, as shown in FIG. 22, a robot having as the drive portion 4, a robot arm which picks up a target object h1 carried on a carrier line and sorts it in accordance with the size is assumed.

The size calculator 11 acquires the size of the target object h1 from the image 2A and the distance map 2B generated by the imaging apparatus 100. The determination module 13 firstly determines whether the size of the target object h1 is the size of an object which can be picked up, and if the size of the target object h1 is the size of an object which can be picked up, the determination module 13 secondly determines the sorting destination of the target object h1. If the size of the target object h1 is not the size of an object which can be picked up (including both a case where the size of the target object h1 is less than an allowable range and a case where the size of the target object h1 is greater than the allowable range), the mobile object controller 14 may control the drive of the drive portion 4 to perform an operation other than the operation for picking up the target object h1, may display a warning on the display portion, or may output a warning sound from the audio output portion. Further, if the size of the target object h1 is the size of an object which can be picked up and the sorting destination of the target object h1 is determined, the determination module 13 transmits a signal for carrying the target object h1 to the sorting destination to the mobile object controller 14. When receiving the signal, the mobile object controller 14 controls the drive of the drive portion 4 to carry the target object h1 to the instructed place.

Alternatively, a plurality of robots may be arranged along the carrier line, and each robot may acquire the size of a target object h1 such that the robot picks up only a target object h1 of a size of a predetermined range.

Note that the robot is not limited to an industrial robot and may also be realized as a home robot such as a cleaning robot which autonomously moves and cleans a floor. In the case of a cleaning robot, By applying the processing apparatus 1-2, for example, whether the size of a dust is the size of an object which can pass through the suction opening is determined, and if the size of the dust is the size of an object which is likely to be stuck in the suction opening when the object is sucked in, suction can be temporarily stopped and the robot can be moved away from this place, the moving route can be changed, or various control can be performed. Further, in an autonomously-moving device such as a cleaning robot, recently, a self-location estimation technique which is referred to as simultaneous localization and mapping (SLAM) has been gaining attention, and the processing apparatus 1-2 which can acquire the distance to an object from the image 2A and the distance map 2B can be applied to the self-location estimation using the SLAM.

### Third Embodiment

Next, a third embodiment will be described. Hereinafter, structures the same as those of the first embodiment or the second embodiment will be denoted by the same reference numbers, and to avoid redundancy, detailed description of the same structures will be omitted.

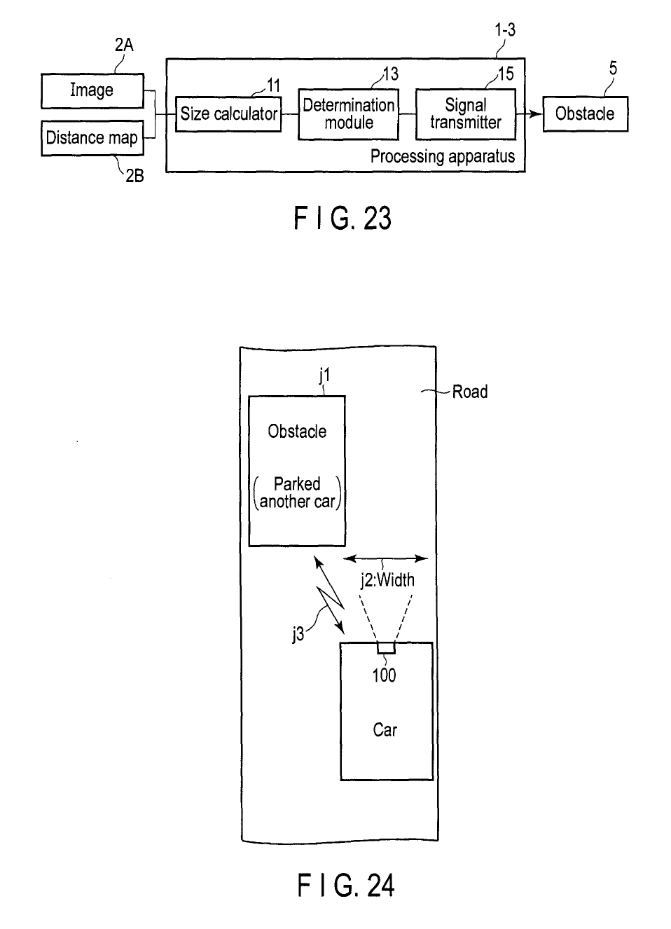

FIG. 23 is a diagram showing an example of the functional block of a processing apparatus of the third embodiment.

The processing apparatus 1 calculates the size of an object on the image 2A from the acquired image 2A and distance map (distance image) 2B, and performs communication with an obstacle 5 based on the calculated size of the object.

As shown in FIG. 23, a processing apparatus 1-3 includes the size calculator 11, the determination module 13 and a signal transmitter 15.

The size calculator 11 is a processing portion having the function of calculating the size of an object on the image 2A from the image 2A and the distance map 2B. The determination module 13 is a processing portion having the function of determining how to drive the drive portion 4 based on the size of an object. The signal transmitter 15 is a processing portion having the function of performing communication with the obstacle 5 based on the determination of the determination module 13. The hardware structure of the processing apparatus 1-3 is similar to that of the processing apparatus 1 of the first embodiment and that of the processing apparatus 1-2 of the second embodiment, and similarly, the processing portions of the processing apparatus 1-3 may be realized as a single processor or a plurality of processors, for example.

Further, the processing apparatus 1-3 may constitute a processing system together with the imaging apparatus (which generates the image 2A and the distance map 2B). The processing system may be realized, for example, as a mobile object such as a vehicle, a flying object or a robot with a camera function.

Now, it is assumed that the processing apparatus 1-2 is applied to a support system which supports the control and operation of a mobile object such as a car and the imaging apparatus 100 is mounted in such a manner as to capture an image in the traveling direction. Further, as shown in FIG. 24, a situation where the car is running on a road and another car (obstacle j1) is parked on the road is assumed.

In this case, the size calculator 11 of the processing apparatus 1-3 measures a width j2 of a space beside the other car (obstacle j1) from the image 2A and the distance map 2B generated by the imaging apparatus 100. The determination module 13 determines whether the width j2 is such a width that the car can pass through, and if the car cannot pass through, the determination module 13 transmits a signal for urging relocation of the other car (obstacle j1) to the signal transmitter 15. When receiving the signal, the signal transmitter 15 outputs a signal for using relocation to the other car (obstacle j1).

Further, when another car (obstacle j1) is running on a road as an oncoming car, the size of the other car (obstacle j1) or the size of a space beside the other car (obstacle j1) is acquired, and if it is determined that the car cannot pass the other car (obstacle j1) on the road, this is notified to the other car (obstacle j1) as quickly as possible, and in this way, accidental contact, etc., can be prevented beforehand. The determination module 13 may acquire the size of the other car (obstacle j1), the size of the space beside the other car (obstacle j1), etc., as needed. For example, if the door of the other car (obstacle j1) is opened and the width is increased, the determination module 13 may output a signal for calling the attention of passengers (including not only a driver but also a fellow passenger) of the other car (object j1) who may get out of the other car (obstacle j1), from the signal transmitter 15 to the other car (obstacle j1). By acquiring the size of the other car (obstacle j1), the size of the space beside the other car (obstacle j1), etc., as needed, even if the other car (obstacle j1) changes from a state where the door of the other car (obstacle j1) is closed and the space is wide enough for the car to pass through, to a state where the door of the other car (obstacle j1) is opened and the space is not wide enough for the car to pass through, etc., the situation can still be appropriately handled.

As described above, according to the first to third embodiments, the size of an object can be acquired by a monocular camera.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1.-12. (canceled)

13. A vehicular processing system comprising:
a memory; and
a processor electrically coupled to the memory and configured to:
calculate a size of an object based on a distance map, the distance map being acquired together with an image at one image capture by a single imaging optical system, information indicative of a distance to the object included in the image being mapped in the distance map; and
transmit a signal to determine a drive method of a vehicle based on the size of the object.

14. The vehicular processing system of claim 13, wherein the distance map is acquired by using a blur function of a blur included in the image.

15. The vehicular processing system of claim 14, wherein the image and the distance map are acquired by the single optical system which generates an image which includes a first wavelength component and a second wavelength component, a blur function of the first wavelength component being symmetrical, a blur function of the second wavelength component being asymmetrical.

16. The vehicular processing system of claim 14, wherein the processor is configured to transmit a signal for urging another vehicle to relocate.

17. The vehicular processing system of claim 14, wherein the processor is configured to acquire a size of another vehicle or a size of a space beside another car on a road, and to determine whether the vehicle can pass the other car on the road.

18. The vehicular processing system of claim 17, wherein the processor is configured to determine to notify the other vehicle that the vehicle and the other vehicle cannot pass each other on the road, as the drive method of the vehicle, when determining that the vehicle cannot pass the other vehicle on the road.

19. The vehicular processing system of claim 14, wherein the processor is configured to acquire a size of a step, and to determine whether the vehicle can run over the step.

20. The vehicular processing system of claim 14, wherein the processor is configured to acquire a size between a first object and a second object, and to determine whether the vehicle can pass between the first object and the second object.

21. The vehicular processing system of claim 13, wherein the image and the distance map are acquired by the single optical system which generates an image which includes a first wavelength component and a second wavelength component, a blur function of the first wavelength component being symmetrical, a blur function of the second wavelength component being asymmetrical.

22. The vehicular processing system of claim 21, wherein the processor is configured to transmit a signal for urging another vehicle to relocate.

23. The vehicular processing system of claim 21, wherein the processor is configured to acquire a size of another vehicle or a size of a space beside another car on a road, and to determine whether the vehicle can pass the other car on the road.

24. The vehicular processing system of claim 23, wherein the processor is configured to determine to notify the other vehicle that the vehicle and the other vehicle cannot pass each other on the road, as the drive method of the vehicle, when determining that the vehicle cannot pass the other vehicle on the road.

25. The vehicular processing system of claim 21, wherein the processor is configured to acquire a size of a step, and to determine whether the vehicle can run over the step.

26. The vehicular processing system of claim 21, wherein the processor is configured to acquire a size between a first object and a second object, and to determine whether the vehicle can pass between the first object and the second object.

27. The vehicular processing system of claim 13, wherein the processor is configured to transmit a signal for urging another vehicle to relocate.

28. The vehicular processing system of claim 13, wherein the processor is configured to acquire a size of another vehicle or a size of a space beside another car on a road, and to determine whether the vehicle can pass the other car on the road.

29. The vehicular processing system of claim 28, wherein the processor is configured to determine to notify the other vehicle that the vehicle and the other vehicle cannot pass each other on the road, as the drive method of the vehicle, when determining that the vehicle cannot pass the other vehicle on the road.

30. The vehicular processing system of claim 13, wherein the processor is configured to acquire a size of a step, and to determine whether the vehicle can run over the step.

31. The vehicular processing system of claim 13, wherein the processor is configured to acquire a size between a first object and a second object, and to determine whether the vehicle can pass between the first object and the second object.
